(19) United States
(12) Patent Application Publication
(10) Pub. No.: US 2005/0280268 A1
(43) Pub. Date: Dec. 22, 2005

(54) Motor vehicle front with a cover in the center of the spoiler area for improved pedestrian protection in a collision

(76) Inventors: Andreas Dehn, Tuebingen (DE); Hans-Peter Maier, Nagold (DE); Markus Mayer, Stuttgart (DE); Hans-Olaf Petersen, Stuttgart (DE); Jochen Roesch, Boeblingen (DE); Johannes Sand, Stuttgart (DE); Sven Zacheiss, Kleinheubach (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/143,446

(22) Filed: Jun. 3, 2005

(30) Foreign Application Priority Data
Jun. 3, 2004 (DE) 10 2004 027 169.0

(51) Int. Cl. B60R 19/03

(52) U.S. Cl. 293/120

(57) ABSTRACT

The front of a motor vehicle has a bumper and a bumper lining stretching to a spoiler area located below the bumper and capable of being mounted on the cover, which is a supplemental part at least in the center of the spoiler area and the bumper lining. The cover has a downward and rearward pointing extension relative to the motor vehicle, which stretches at least section-wise on the inside of the bumper lining, provides for direct fastening and stiffening, and includes flat and essentially formfitting portions.

This application claims the priority of German application 10 2004 027 169.0, filed Jun. 3, 2004, the disclosure of which is expressly incorporated by reference herein.

### BACKGROUND AND SUMMARY OF THE INVENTION

This invention concerns a front of a motor vehicle with a bumper and a bumper lining as well as a cover which is provided for the lower center spoiler area of the front of the motor vehicle in which the bumper lining stretches down below the bumper to the spoiler area and the cover is mountable as an optional part on the bumper lining at least in the center of the spoiler area.

The present invention concerns, specifically, the front of a motor vehicle which has been further improved to prevent injury to pedestrians during a frontal impact. Current and future safety requirements with respect to frontal collisions with pedestrians make it necessary to increase measures related to safety. Therefore, tests and criteria have been established for the external safety of motor vehicles. In a leg impact test, for example, the knee bending angles and the shearing force against the knee are safety criteria which must be met or exceeded. The purpose of having a knee bending angle that is as small as possible is to prevent the pedestrian from ending up under the front of the vehicle and, instead, to push the legs, and especially the lower legs, away from under the pedestrian in order to make possible a rollover movement of the body of the pedestrian over the hood of the motor vehicle. For this reason, it is primarily necessary to achieve a recoil of the legs of a pedestrian, especially in the lower leg area, while preventing a body penetration of the vehicle undergoing a deformation. Efforts made to achieve this in present day motor vehicles consist of providing an added girder subject to bending in the spoiler area with a superimposed foam impact damper other than the bumper itself. Because of the additional components and assembly steps required, these efforts result in increased costs.

A front section of a motor vehicle, known from German document DE 101 12 424 A1, has a bumper and an air conducting component. The air conducting component here is formed into a protruding wing such that during the frontal impact the air flow openings of the radiator introduce additional stiffness to the front of the motor vehicle. The additional stiffening of the cooling fan area with the air stream flow provides a stronger push against the lower leg of a seized pedestrian so that a roll over by the pedestrian, over the hood of the engine, is set into motion. Stiffening with the use of a protruding wing section is effective but, nevertheless, space intensive, and the wing section can only be built in if there is sufficient room between the air conducting part and the spoiler area.

The present invention has as one object the provision of a front of a motor vehicle which, especially in the terms of external safety of pedestrians, will be further improved without producing an increased need for space and/or an increased number of parts.

This object is achieved by way of a cover which has, relative to the motor vehicle, a downward and rearward pointing stiffening extension having at least one section which extends flat on an inside of the bumper lining, which provides for direct fastening to the bumper lining, and which is designed to be essentially formfitting with respect to the inside of the bumper lining. Advantageous arrangements of and further advances provided by this invention are also claimed.

A front of a motor vehicle according to the invention is furnished with a bumper and a bumper lining, which extends at least up to beneath the bumper in a spoiler area and is provided with a cover which, as an attachment in the central spoiler, can be mounted on the bumper lining. With respect to the motor vehicle, the cover has a downward and rearward pointing extension which, at least section wise, abuts flat and is substantially formfitting to the inside of the bumper lining up to its direct tie up and stiffening. The cover is preferably a cover for a cooling air entry opening in the central lower spoiler area. It could, nevertheless, be a different type of a frontal cover, as long as it is located in the lower shank area of the pedestrians. The cover, according to the invention, is equipped with a rearward pointing formfitting extension to the inside of a bumper lining, which stretches so that, at least section wise, the cover is stretched flat along the inner contour, so that the external coating of the body (and/or the bumper lining) is relatively extensively stiffened in the shank area of the pedestrian. Under the extension according to the invention, a section also stretches outside of the cover area itself to the frontal area-wide stiffening in the spoiler area. This stiffening by an integral extension section of an already planned frontal cover has an additional advantage that it is not very space demanding. The at least section-wise flat stretch on the inner wall of the outside contour of the body avoids a projecting section or projecting elements in the interior. According to an advantageous aspect of the invention, the extension is located on the interior of the frontal lining in the spoiler area. Through the form conforming, at least section-wise, to a planned flat stretch of the extension on the internal side of the bumper lining, a certain type of sandwich type interlocking structure is available in the area. Through a suitable selection of materials, this structure leads, on the basis of its connection, to a firmer stiffening than if only stiffening ribs on the internal side were planned. Additionally, the at least section-wise planned, flat and formfitting extension has a direct connection to the cover on the internal side of the bumper lining. An integral carrier located behind it has the advantage that the frontal stiffening in the shank area is thereby extensive and not only selective. There are no gaps in stiffening in the area of a shank of the pedestrians. An injury critical penetration of a shank in the case of leg impact, because of the deformation of the front lining of the car body, is thus effectively prevented in every section of the front area. The achievable maximum knee bending angles are, therefore, further reduced in this motor vehicle front according to the invention. Future safety requirements can thus easily be achieved and complied with, without required additional separate components.

According to an advantageous arrangement, the bumper lining on the interior side furnished stiffening ribs has projections aimed along (parallel) to the motor vehicle lengthwise axis. The stiffening ribs are advantageously planned in the front area of the bumper lining. The stiffening ribs also increase the effectiveness of the stiffening in acting together with the flat abutting section of the cover extension in this area.

The stiffening ribs on the interior side of the bumper lining can be made as parallel, longitudinal ribs integrated from the material of the bumper lining. The flat and formfitting stiffening sections of the extension abutting on the inside of the cover, according to the invention, can preferably be arranged between the stiffening ribs of the bumper lining and adjusted at intervals as planned. In this way, there would also be a flat lateral side arrangement of the lateral side surfaces of the stiffening extension of the cover rearwards, which also, based on the sandwich type integration effect, would further increase extensive stiffening in the lower shank area. The fastening and construction of the cover and its extension on the bumper lining, and/or on the bordering carrier elements of the motor vehicle body, can be accomplished using known methods and, specifically, can be done by a body-bound rivet connection. In this manner, the material independent parts can be assembled easily.

According to another advantageous arrangement of the invention, the extension of the cover itself has additional stiffening ribs on the top side. The stiffening ribs can be planned, above all, in the bending area, i.e. in the transition from the front spoiler area to the adjacent ground area. The stiffening ribs can then be used as bridging, projecting material sections. This provides for additional stiffening at a very low weight of the cover together with its extension. The frontal covering and the extension section pointing rearwards and downwards create, in a cross section, an L-shaped form element that, based on this form, already has a relatively good stiffening of its own. When lengthwise bridging ribs are additionally planned topside at the bending point of the L, the stiffening is again further improved.

According to another advantageous arrangement of the invention, the extension of the cover for stiffening is also adapted to have hollow profile sections. The hollow profile sections themselves can be constructed in the extension section of the cover or to act in combination with the bumper lining and/or other car body components. The hollow profile sections are preferably aligned lengthwise in the direction of the longitudinal axis of the motor vehicle so that there is additional stiffening, similar to traditional lengthwise carriers, made available directly and formfitting in arrangement of the frontal bottom spoiler area of the motor vehicle body.

According to another advantageous arrangement of the invention, the cover of the cool air intake grating is designed with a rearward extension in such way that its direct tie up with the integral carrier will act on improving the support. The cool air intake grating is traditionally planned to be mounted as an additional part in an opening for that grating in the frontal part of the motor vehicle. This part, which is planned in any case according to this invention, will have an extension rearward with a support section on the carrier elements of the car body. The cover according to the invention, in addition to closing the cooling air intake opening, is made in the simplest possible way, requires only a small space, and, at the same time, provides a relatively extensive stiffening at the lower shank area of the pedestrian in front of the motor vehicle.

According to another advantageous arrangement of the invention, at least on the rearward pointing extension, fastening holes provide for attachment to the bumper cover and/or on the carrier elements of the car body. The fastening holes can, for example, be used for fastening screws or body bound rivets, or serve for any other measure known to one skilled in the art.

According to another advantageous arrangement, the extension aimed rearward for stiffening the areas concerned with support sections is intended for support of a back side carrier of the car body. In addition to stiffening the cover itself and increasing the deformation resilience in the frontal area, a supplemental backside support will be available so that deformation in the frontal spoiler area will be even more effectively prevented. In a combined effect with the bumper lining according to the invention, the cover provides, with its rearward pointing extension and support for the cover on a carrier in the engine space, a type of extensive impact ram available over its entire width so that a lower shank impacting there is effectively deflected. This takes place without requiring space intensive or costly additional construction components.

The cover according to the invention, together with its extension, can be completed using any type of production and with the use of known production materials. The method and materials can be chosen in such way that a certain amount of elastic deformation, at least at the support points, can be present. In this manner, the recoil impact effect on the lower shank will be further increased. The cover according to the invention can, for example, be produced in form of an injection molding from synthetic materials. Alternatively, the cover, together with a corresponding interior side of the motor vehicle front constructed extension, can be made as a structural sheet metal section from deep drawn or pulled sheet metal.

Additional advantages and characteristics of the invention are provided in the following detailed description in which the invention is described in greater detail with reference to enclosed drawings.

### BRIEF DESCRIPTION OF THE DRAWINGS

FIG. 1 is a schematic perspective view from the interior of a motor vehicle front part component area with a cover according to the invention which is mounted between two receptacles for a fog headlight.

FIG. 2 is a schematic perspective view of the cover of FIG. 1 showing the rearward pointed extension.

### DETAILED DESCRIPTION OF THE INVENTION

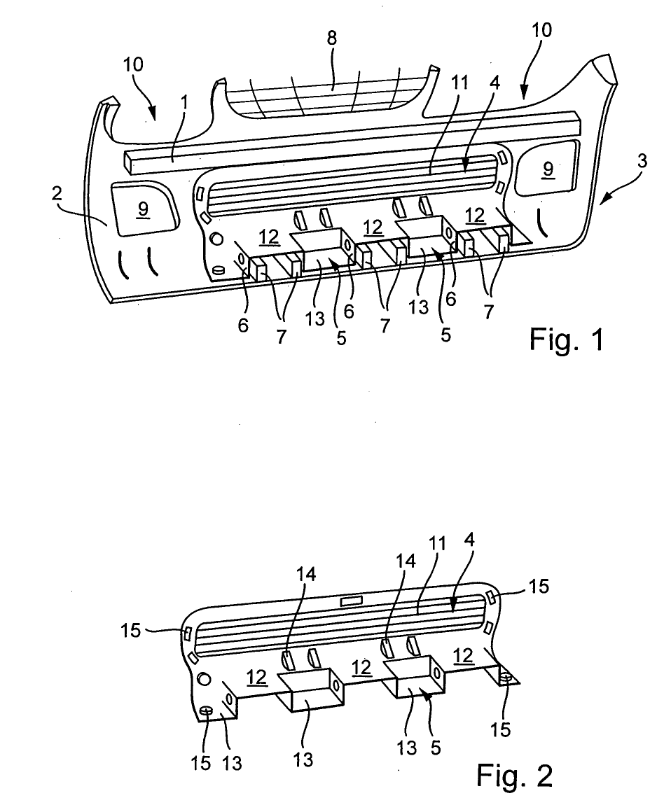

FIG. 1 is a schematic perspective view from the inside of a front area of a motor vehicle with an example of a cover according to the invention in the form of an air cooling intake grating. Below the openings 10 for the front headlights (not shown) and a centric radiator grating 8 for the main radiator of the motor vehicle, a transverse girder forms a bumper 1 behind the bumper lining 2. The bottom spoiler area 3 is the area in the front head-on shell of the car body, which is located below the level of the bumper 1. Other than bumper 1, which shows a sufficient resilience to repulsion of the legs of a pedestrian, the spoiler area 3 is traditionally not made stiff. An encountering lower shank of a pedestrian can, therefore, penetrate in this area, which can lead to serious injuries. The cover 4 according to the invention is, for this reason, not planned as a simple cover only for closing the frontal opening in the spoiler area 3, but has at least one downward and rearward pointing, specifically designed extension 5 (according to the inside contour) for stiffening the lower head-on area of the motor vehicle. The cover 4 in this example is a cover intended for the cool air intake grating 11 directly below the bumper 1 and between the openings 9 for the fog lights (themselves not shown). The cover 4, with the extension 5, is designed to be formfitting to the inside of the spoiler area 3, respectively the bumper lining 2. The extension 5 is, therefore, flat on the inside, at least section-wise, to the adjacent type of lining which, in this example, is formfitting in contact with the stiffening ribs 7, and is additionally (but not necessarily) planned for the inside of the bumper lining. In this way, a direct tie of the bumper lining with the stiffening extension section 5 is used for the cover 4 according to the invention.

Each rearward extension 5 in this example has a flat elevation 12 and an indentation 13 which, corresponding to the lengthwise pointed and protruding ribs 7, is arranged on the inside of the bumper lining 2. That provides for additional sidewise support surfaces 6 of the cover 4 in the stiffening lining 2. This creates additional lateral side support surfaces 6 for the cover 4 in the stiffening area of the extension 5, which is located laterally on the flanks of the stiffening ribs 7. The flat elevations and indentations 12 form a type of one-sided open hollow profile, which additionally improves the stiffening of each extension 5 of the cover 4. The cover 4 itself defines a transition between the frontal cooling air intake grating 11 and each rearward pointing, cross-sectionally L-shaped deflecting extension 5 which is provided with lengthwise pointed stiffening ribs 14 bridging the rising section of the cooling air grating 11 of the cover 4 and the downward and rearward pointing extension 5. The fastening and mounting of the cover 4 on the bumper lining 2 and on other car body serial type parts takes place in this example through fastening openings 15, which are provided in the edge sided areas of the cover 4. On the side of the cooling air intake gratings 11, long hole-type openings, intended for the clip-on of synthetic material clamping or similar elements, are provided. Round openings are located at the bottom of the car body of the motor vehicle, for example, to provide for mounting with the use of body bound rivets or screws.

As shown in FIG. 2, an integrated stiffening element, together with a centric covering of the car body, here with a cooling air intake grating 11, is be made available. This will make it possible to stiffen effectively the entire front lower spoiler area without space consuming elements or additional construction components. Pedestrian safety will thus be increased, since a small knee bending angle can be realized due to the low deformation ability of this area at the lower shank area of the pedestrians. The invention is not limited to the examples shown, but encompasses all design types which lie within the scope of the claims. Specifically, the type and arrangement of the stiffening ribs and/or supporting surfaces and/or elevations and indentations can be different from those of the represented example. Also, the overall form of the cover 4 is not limited to the essentially L-shaped form in side view shown, and can include other sections, for example, in the lateral side area. The cover can alternatively be used, for example in a vehicle without a fog light. The cover 4, together with its extension 5, can be made from a synthetic material or sheet metal for the purposes of stiffening. In the latter case, production can be made cost efficient with traditional molded plastics and bending machines. The type of the fastening on the bumper lining and on the adjacent car body area can also be made in other ways than by the described methods, for example, by welding or bolting.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A motor vehicle front comprising:
a bumper,
a bumper lining which stretches down below the bumper to a spoiler area, and
a cover which is mountable as an optional part on the bumper lining at least in a center of the spoiler area,
wherein the cover has, relative to the motor vehicle, a downward and rearward pointing stiffening extension having at least one section which extends flat on an inside of the bumper lining,
wherein the cover provides for direct fastening to the bumper lining, and
wherein the cover is designed to be essentially formfitting with respect to the inside of the bumper lining.

2. The motor vehicle front according to claim 1, wherein the inside of the bumper lining is furnished with stiffening ribs.

3. The motor vehicle front according to claim 2, wherein the extension of the cover has flat indentations and elevations in the direction of a vehicle lengthwise axis which are adjacent to the bumper lining and the stiffening ribs and are in contact or are form fittingly located adjacent to bumper lining and the stiffening ribs.

4. The motor vehicle front according to claim 1, wherein the extension of the cover has stiffening ribs on its top side.

5. The motor vehicle front according to claim 1, wherein the extension of the cover is provided with hollow profile sections for stiffening.

6. The motor vehicle front according to claim 1, wherein the cover is adapted to define or provide for a cooling air intake grating for a supplemental cooling unit of the motor vehicle.

7. The motor vehicle front according to claim 1, wherein the cover includes fastening openings for fastening the cover to the bumper lining.

8. The motor vehicle front according to claim 2, wherein the cover includes lateral support surfaces adapted for support on the stiffening ribs.

9. The motor vehicle front according to claim 3, wherein the cover includes lateral support surfaces adapted for support on the stiffening ribs.

10. The motor vehicle front according to claim 2, wherein the extension of the cover has stiffening ribs on its top side.

11. The motor vehicle front according to claim 2, wherein the extension of the cover is provided with hollow profile sections for stiffening.

12. The motor vehicle front according to claim 2, wherein the cover is adapted to define or provide for a cooling air intake grating for a supplemental cooling unit of the motor vehicle.

13. The motor vehicle front according to claim 2, wherein the cover includes fastening openings for fastening the cover to the bumper lining.

14. The motor vehicle front according to claim 3, wherein the extension of the cover has stiffening ribs on its top side.

15. The motor vehicle front according to claim 3, wherein the extension of the cover is provided with hollow profile sections for stiffening.

16. The motor vehicle front according to claim 3, wherein the cover is adapted to define or provide for a cooling air intake grating for a supplemental cooling unit of the motor vehicle.

17. The motor vehicle front according to claim 3, wherein the cover includes fastening openings for fastening the cover to the bumper lining.

18. The motor vehicle front according to claim 4, wherein the extension of the cover is provided with hollow profile sections for stiffening.

19. The motor vehicle front according to claim 4, wherein the cover is adapted to define or provide for a cooling air intake grating for a supplemental cooling unit of the motor vehicle.

20. The motor vehicle front according to claim 4, wherein the cover includes fastening openings for fastening the cover to the bumper lining.
